(19) United States
(12) Patent Application Publication
(10) Pub. No.: US 2013/0231157 A1
(43) Pub. Date: Sep. 5, 2013

(54) CELLULAR PHONE WITH CAMERA AT FRONT EDGE AREA

(71) Applicant: Jeffrey Chung, San Jose, CA (US)

(72) Inventor: Jeffrey Chung, San Jose, CA (US)

(21) Appl. No.: 13/772,808

(22) Filed: Feb. 21, 2013

Related U.S. Application Data
(60) Provisional application No. 61/605,789, filed on Mar. 2, 2012.

(51) Int. Cl. H04M 1/02

(52) U.S. Cl. CPC H04M 1/0264
USPC 455/556.1

(57) ABSTRACT

A cellular phone includes a case defining opposite primary faces with the display on one of the primary faces. A camera lens is located around a front edge area of the case so as to be activated to efficiently capture the front sight image when the cellular phone is held in the palm of the user in a lying manner and the user is moving wherein the contents derived from the Internet communication and the front sight image are both shown on the screen in either an overlapped manner or not and an optional translucent background layer may be provided as an interface with regard to the front sight image so as to have both the contents and the front sight image viewable on the screen.

This application claims benefits of the provisional application of 61/605,789 filed on Mar. 2, 2012.

### FIELD OF THE INVENTION

The present invention relates to a cellular phone, and particularly to a cellular phone equipped with a camera lens essentially around a front (top) edge of the case of the cellular phone so as to easily capture the front circumstance of the user and present the corresponding image on at least a portion of the screen when the user lowers his head to view the other matters on the screen either walking or sitting.

### DESCRIPTION OF THE RELATED ARTS

The traditional cellar phone is equipped with one camera lens on the back face of the case for easily taking the picture in front of the user while simultaneously allowing the user to display the corresponding image for adjusting the object range of such an image before recording the picture. Some luxurious type may further include another camera lens on the front face of the case for taking the picture showing self-image of the user. Anyhow, in the recent years, it is very popular that more people, namely the smart phone addicts, like to read or view the contents shown on the screen of the cellular phone during either sitting or even walking. Understandably, the more they concentrate on the screen by lowering their heads, the less they are aware of the circumstances. Such a condition may lead them to miss or ignore some important matters in front of them, especially during walking. For example, many people like to read the text during walking. Anyhow, lowering the head to read the text shown on the display of the cellular phone without properly viewing the circumstance in the front may be somewhat dangerous to the walker if a ramped portion on the road in the front.

Hence, it is desired for the user to obtain the front sight during walking when he lowers his head to read the text on the screen of the cellular phone.

### SUMMARY OF THE INVENTION

Accordingly, an object of the invention is to provide a cellular phone having capability of viewing the front sight when the user is walking and viewing the contents shown on the screen of the phone. The cellular phone includes a case of a rectangular configuration defining opposite primary faces with the screen or display on one thereof. A camera lens is located around a front (top) edge of the case relative to the screen so as to be activated to capture the sight in the front when the user holds the cellular phone in his palm generally in lying manner for texting reading or viewing contents of the websites wherein the image of the front sight may be shown, either at a corner area on the screen without interfering with other contents on the screen, or on the full area of the screen under condition that the text of messages associated with an optional background translucent/transparent background layer, is overlapped with the image of the front sight so as to allow the user to read the text of the messages and viewing the front image on the same area of the screen. Therefore, the smart phone addicts may capture both the Internet information via the smart phone internally and the front sight externally so as to be in a safer situation.

Other objects, advantages and novel features of the instant invention will become more apparent from the following detailed description when taken in conjunction with the accompanying drawings.

### BRIEF DESCRIPTION OF THE DRAWINGS

FIG. 1 is a traditional cellular phone.

FIG. 2 is a forward perspective view of the present embodiment of the cellular phone of the instant invention.

FIG. 3 shows how the cellular phone is lying in the palm of the user and intends to display both the front sight image and the text of the messages on the screen simultaneously.

FIG. 4 is a picture showing the front sight with a dangerous situation if the walker does not pay attention thereto.

FIG. 5 is an elevational view of the cellular phone of the instant invention to show that the front sight image is shown on the corner area of the screen.

FIG. 6 is an elevational view of the cellular phone of the instant invention to show that the front sight image may be shown on the full screen, rather than at the corner, of the cellular phone with optionally a translucent/transparent background layer to be an interface between the text and the front sight image for easily viewing the image and reading the text simultaneously.

FIG. 7 is an image shown on the screen and capturing the front sight of the road with the text of the messages overlapped thereon via a translucent background layer thereof.

FIG. 8 is an image shown on the screen and capturing the front sight of the road with the text of messages overlapped thereon without a translucent background layer thereof.

FIG. 9 is a rearward perspective view of the present embodiment of the cellular phone of the instant invention.

FIG. 10 is an alternate embodiment of the instant invention to show the camera lens on the front edge of the case, may be rotated so as to function as the traditional camera set on the back face of the case for taking pictures when the cellular phone is held in a regular upstanding manner.

### DETAILED DESCRIPTION OF THE PREFERRED EMBODIMENT

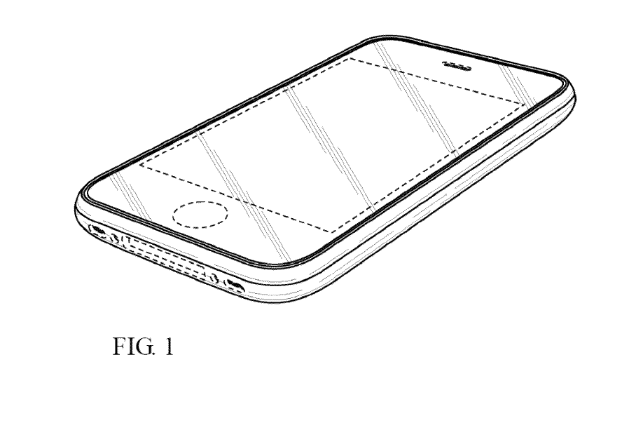

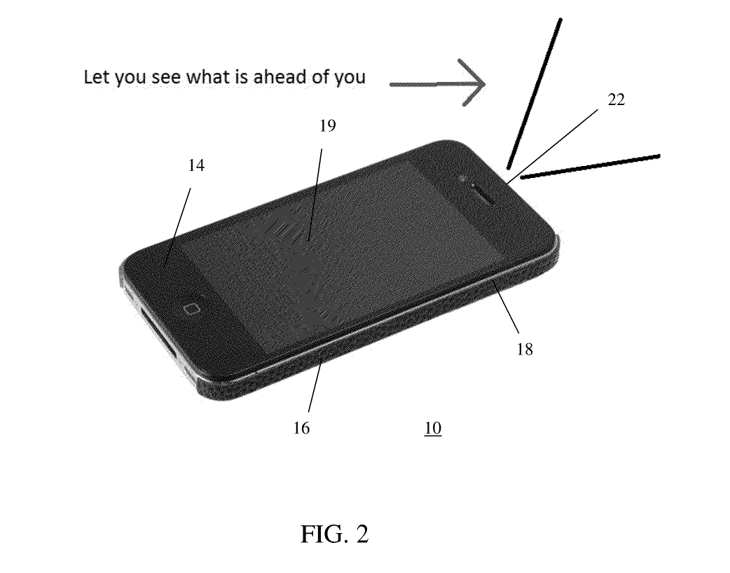

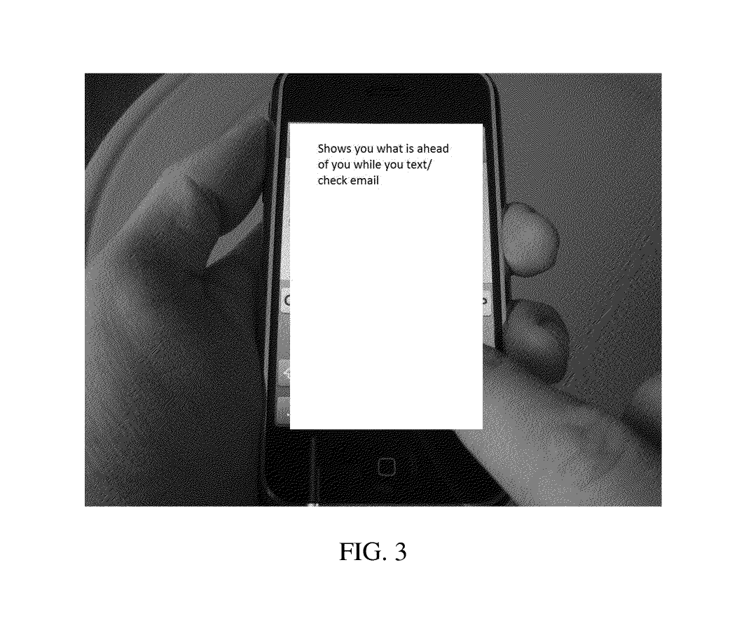

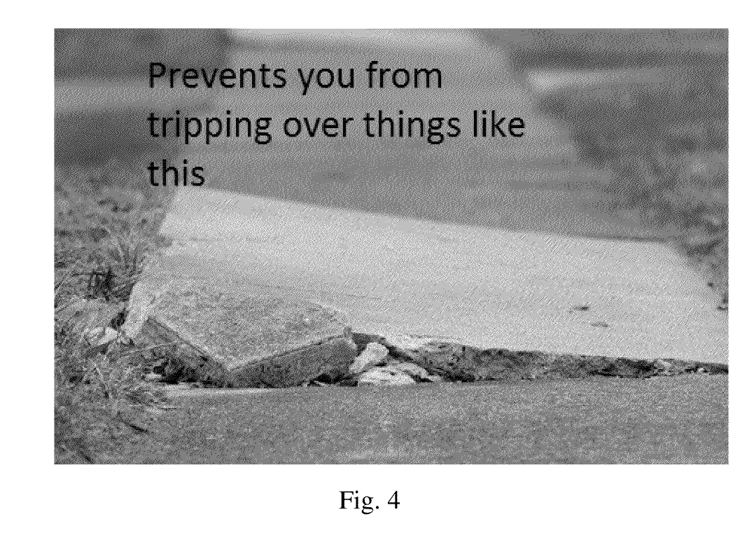

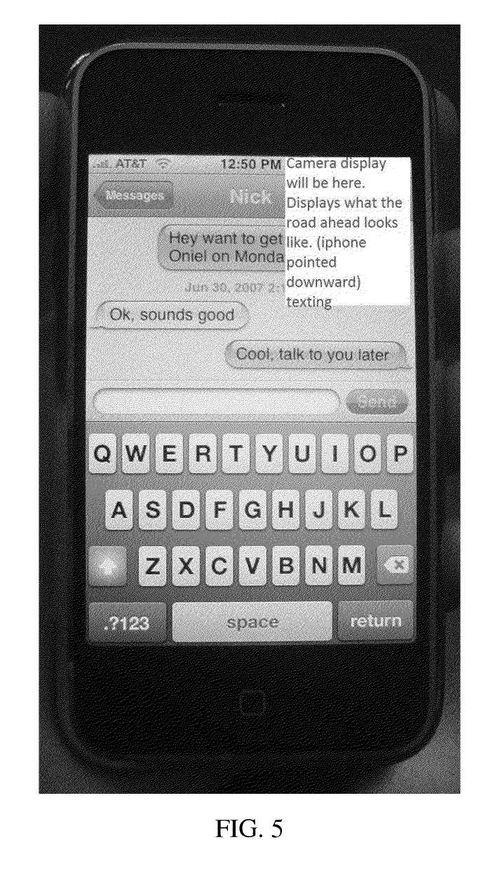

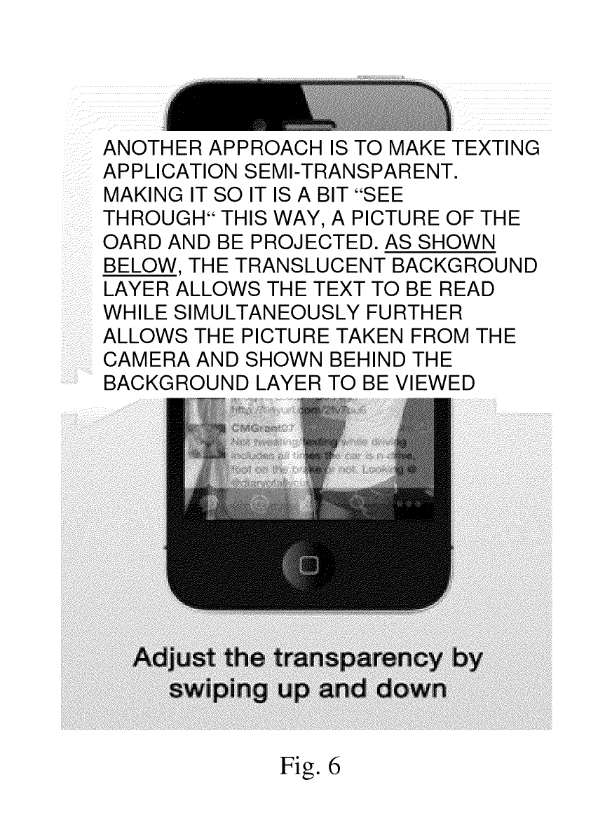

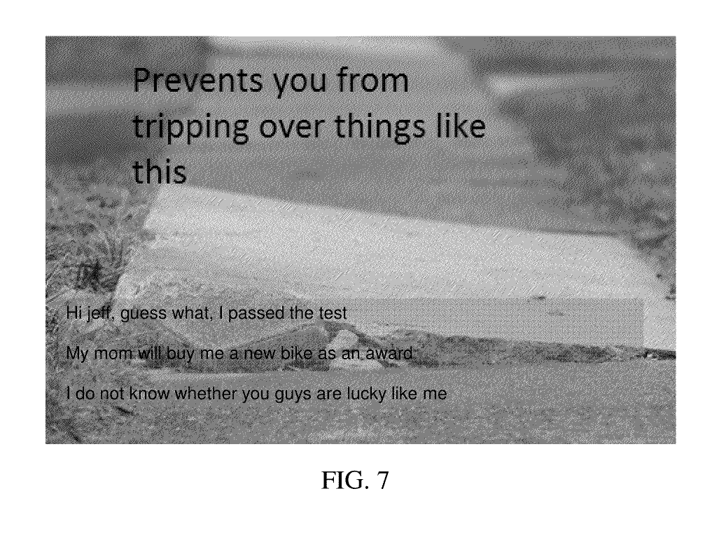

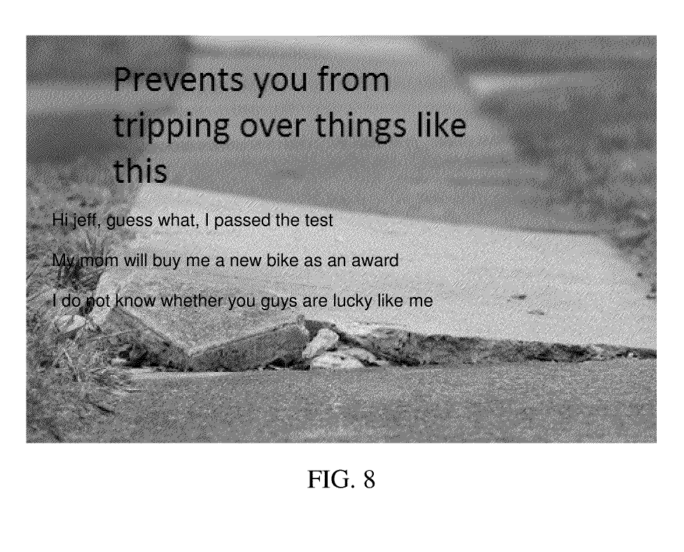

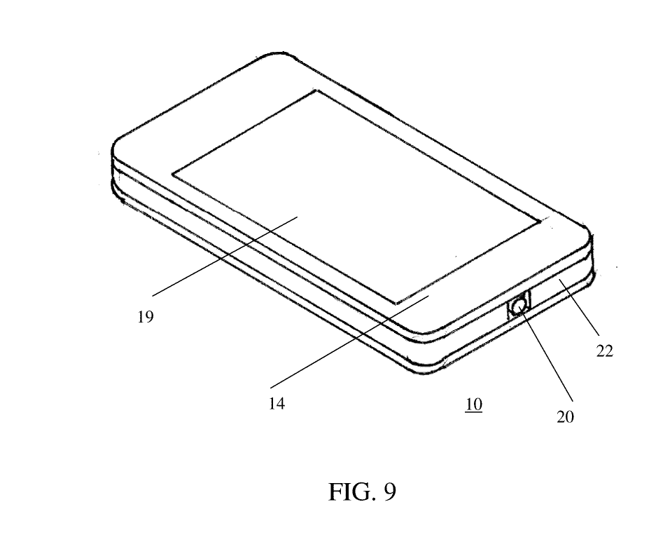

Referring to FIGS. 1-10, the traditional cellular phone is shown in FIG. 1 while in FIGS. 2 and 9 the instant invention is to provide a cellular phone 10 including a rectangular case 12 to contain internal parts with two opposite primary faces 14, 16 surrounded by a circumferential edge region 18. A screen or display 19 is disposed on the upward primary face 14. A camera lens 20 is disposed on a front (top) edge area 22 of said circumferential edge region 18 so as to efficiently capture the front image without obstruction when the case is held in a horizontal or lying manner, referring to FIG. 3. The front sight image captured by the camera lens 20 when the case is held in a lying manner, is displayed on the screen 19 either at one corner as shown in FIG. 5 without interfering with intentionally viewed portions of the original contents shown on the remaining portions of the screen 19, or on the full screen 19 as shown in FIGS. 6-8 with optionally a translucent/transparent layer background layer interfaced between the text of the messages and the front sight image without blocking the text. Understandably, via the software, it is easy to adjust the transparency by swiping up and down for easy viewing.

Understandably, by this way the user may easily handle the text/Internet stuff during walking without danger. As well known, the additional camera lens is not really expensive. On the other hand, the front sight image is not for recording but viewing so as not to use too much additional memory or other software. The invention is feasible and practical.

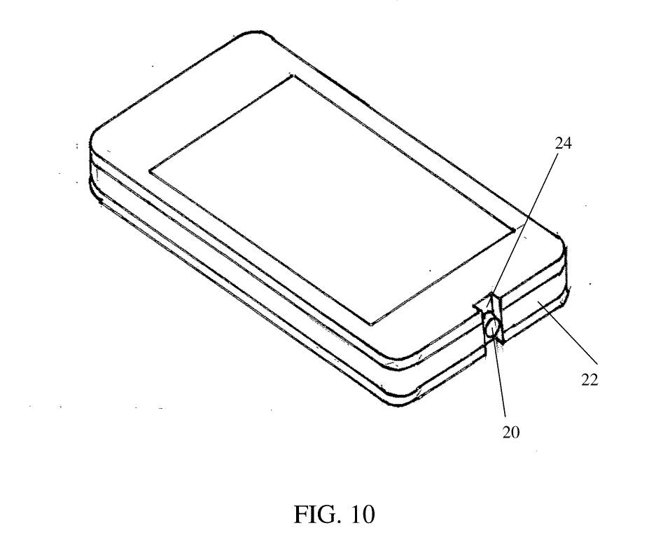

It is also noted that as shown in FIG. 10 the front edge area 22 of the case 12 of the cellular phone 10 may be recessed within a receiving room 24 in three directions instead of only in a forward direction in the first embodiment, and the camera lens set may be directed or rotated in different directions to not only the forward direction as viewing the front sight in a alerting situation introduced in the above embodiment when the case is held in a lying manner, but also the transverse direction as taking the picture in the regular condition when the case is held in a lift-up regular manner.

The spirit of the invention is to equip a camera lens around a front (top) edge area of the case of the cellular phone so as to allow the user to view the front sight optically captured by the camera lens and contents transmitably derived from the Internet simultaneously on the screen. In other words, the smart phone addicts may be aware of the environments rather than only the ground right below the cellular phone.

It is to be understood, however, that even though numerous characteristics and advantages of the present invention have been set forth in the foregoing description, together with details of the structure and function and method of the invention, the disclosure is illustrative only, and changes may be made in detail, especially in mattes of shape, size and arrangement of parts within the principles of the invention to the full extent indicated by the broad general meaning of the terms in which the appended claims are expressed. For example, the so-called front edge area refers to the portion of the circumferential edge of the cellular phone, which is directed to the front when the user holds the cellular phone in a lying manner to view the screen. The so-called smart phone also may include the tablet device capable of Internet communication.

What is claimed is:

1. A smart phone capable of Internet communication, comprising:
a rectangular case to enclose internal parts;
a screen disposed upon one of two opposite primary faces of the case; and
a camera lens disposed around a front edge area of said case so as to efficiently take front sight image when the case is held in a lying manner.

2. The smart phone as claimed in claim 1, wherein the front sight image captured by said camera lens and contents derived from the Internet communication are both viewable on the screen.

3. The smart phone as claimed in claim 2, wherein the front sight image takes a space on the screen while the contents take remaining spaces on the screen without interference.

4. The smart phone as claimed in claim 3, wherein said space is located at a corner of the screen

5. The smart phone as claimed in claim 2, wherein the front sight image and the contents share same areas on the screen.

6. The smart phone as claimed in claim 5, wherein said contents are text of messages.

7. The smart phone as claimed in claim 6, wherein the text is associated with a translucent/transparent layer background layer interfacing with the front sight image.

8. The smart phone as claimed in claim 1, wherein said camera lens is received in a recess in the front edge area, and said recess communicates with an exterior in a forward direction and a transverse direction perpendicular to said forward direction.

9. The smart phone as claimed in claim 8, wherein said camera lens is rotatable in the recess to said forward direction or said transverse direction.

10. A method of operating a smart phone capable of wireless communication, comprising steps of:
providing the smart phone with a case having a screen thereon on a primary face;
providing a camera lens on a front edge area of the case wherein said camera lens is configuration to be capable of capturing front sight image when said case is held in a lying manner; and
simultaneously displaying contents derived from wireless communication and the front sight image captured by the lens on the screen.

11. The method as claimed in claim 10, wherein the contents and the front sight image take different spaces on the screen.

12. The method as claimed in claim 10, wherein the contents are text.

13. The method as claimed in claim 12, wherein a translucent or transparent background layer is associated with the text to be interface with the front sight image.

14. The method as claimed in claim 13, wherein transparency is adjustable to efficiently distinguish the text from the front sight image.

15. The method as claimed in claim 10, wherein said camera lens is configured to be capable of directing to either a forward direction for an alerting situation or a transverse direction for a regular manner.

16. The method as claimed in claim 10, wherein displaying the front sight image is activated when a user is walking.

17. A smart phone capable of Internet communication, comprising:
a rectangular case to enclose internal parts;
a screen disposed upon one of two opposite primary faces of the case; and
a camera lens disposed on said case where the camera lens is essentially fully forwardly communicable with an exterior so as to efficiently take front sight image when the case is held in a lying manner; wherein
the front sight image captured by said camera lens and contents derived from the Internet communication are both viewable and presented on the screen simultaneously.

18. The smart phone as claimed in claim 17, wherein the front sight image takes a space on the screen while the contents take remaining spaces on the screen without interference.

19. The smart phone as claimed in claim 17, wherein the front sight image and the contents share same areas on the screen.

20. The smart phone as claimed in claim 19, wherein said contents are texts of messages.
